(19) United States
(12) Patent Application Publication
(10) Pub. No.: US 2017/0342871 A1
(43) Pub. Date: Nov. 30, 2017

(54) CAMSHAFT PHASE REGULATOR

(71) Applicant: Schaeffler Technologies AG & Co. KG, Herzogenaurach (DE)

(72) Inventor: Yanhua He, Shanghai (CN)

(73) Assignee: Schaeffler Technologies AG & Co. KG, Herzogenaurach (DE)

(21) Appl. No.: 15/535,221

(22) PCT Filed: Oct. 12, 2015
(86) PCT No.: PCT/CN2015/091739

§ 371 Date: Jun. 12, 2017

(30) Foreign Application Priority Data
Dec. 12, 2014 (CN) 201410773099.9

(51) Int. Cl. F01L 1/344; F04C 15/00; F01L 1/02; F02D 13/02; F01L 1/053

(52) U.S. Cl. CPC F01L 1/3442; F04C 15/0073; F01L 1/34409; F01L 1/024; F01L 1/0532; F01L 2001/34479; F02D 13/0238; F01L 2001/3443

(57) ABSTRACT

The present disclosure provides a camshaft phase adjuster, including: a stator provided with a plurality of hydraulic chambers; a rotor rotatably disposed in the stator and provided with a basic body and a plurality of blades fixed to the basic body, the basic body has a first end surface and the second end surface which face opposite directions along an axial direction, the plurality of blades are arranged in intervals along the circumferential direction and divide the hydraulic chambers into first pressure chambers and second pressure chambers, respectively; wherein the basic body is provided with a plurality of first oil holes and a plurality of second oil holes which are communicated with the first pressure chambers and the second pressure chambers, respectively, the second oil hole is provided with at least two oil sub-holes, a first oil sub-hole extends along a radial direction of the basic body and is located on a same plane, with the first oil hole, perpendicular to a central axis of the rotor, the first oil sub-hole communicates with the second pressure chamber, and the second oil sub-hole penetrates through the first end surface along an axial direction of the basic body. Accordingly, technical solution of the present disclosure solves the problems of large in axial dimension and great in mass of existing camshaft phase adjusters.

### TECHNICAL FIELD

The present disclosure generally relates to the technical field of Variable Camshaft Timing (VCT), particularly to, a camshaft phase adjuster.

### BACKGROUND

According to a current operating condition of an internal combustion engine, intake/exhaust valve timing can be controlled via adjusting a phase between the crankshaft and the camshaft, which will bring advantages such as reduction of oil consumption and decrease of harmful substances. A device adapted to adjust the phase between the crankshaft and the camshaft is known as a camshaft phase adjuster.

As shown in FIG. 1, an existing camshaft phase adjuster includes: a stator 1 provided with a plurality of protrusions 11, where the plurality of protrusions 11 extend inwardly along a radial direction, and a hydraulic chamber 12 is defined between two neighboring protrusions 11; and a rotor 2 rotatably disposed in the stator 1, where the rotor 2 is provided with a plurality of blades 21, the plurality of blades 21 extend outwardly along the radial direction, and each blade 21 divides the corresponding hydraulic chamber 12 into a first pressure chamber 12a and a second pressure chamber 12b.

In combination with FIGS. 2 to 4, the rotor 2 is provided with two sets of oil holes, wherein one set of oil holes is defined as first oil holes 22, and another set of oil holes is defined as second oil holes 23. Along an axial direction of the rotor 2, the two sets of oil holes are arranged in intervals. Along the radial direction of the rotor 2, each set of oil holes is arranged in intervals. Wherein, as shown in FIG. 1, the first oil hole 22 communicates with the first pressure chamber 12a, the second oil hole 23 communicates with the second pressure chamber 12b, and the first oil hole 22 and the second oil hole 23 are respectively arranged at two sides of the blade 21.

However, the existing camshaft adjuster has following problems: since the first oil holes 22 and the second oil holes 23 in the rotor are arranged in intervals along the axial direction of the rotor 2, and a sealing between the first oil holes 22 and the second oil holes 23 is required, an interval between the first oil holes 22 and the second oil holes 23 along the axial direction should be at least 3mm, which makes the rotor 2 have a large axial dimension and a great mass. Thus, the entire camshaft phase adjuster has a large axial dimension and a great mass.

Therefore, a modified camshaft phase adjuster is needed to solve above problems.

### SUMMARY

Problems solved by the present disclosure include: the rotor of an existing camshaft phase adjuster has a large axial dimension and a great mass, which makes the entire camshaft phase adjuster have a large axial dimension and a great mass.

In order to solve above recited problem, the present disclosure provides a camshaft phase adjuster including: a stator provided with a plurality of protrusions, wherein the plurality of protrusions are arranged in intervals along a circumferential direction and extend inwardly along a radial direction, and a hydraulic chamber is defined between two of the plurality of protrusions which are neighboring; a rotor rotatably disposed in the stator, wherein the rotor comprises a basic body and a plurality of blades fixed to the basic body, the basic body has a first end surface and a second end surface which face opposite directions along an axial direction, the plurality of blades are arranged in intervals along the circumferential direction and outwardly extend into the hydraulic chambers along the radial direction to divide the hydraulic chambers into first pressure chambers and second pressure chambers, respectively; wherein the basic body is provided with a plurality of first oil holes and a plurality of second oil holes, the plurality of first oil holes are arranged in intervals along the circumferential direction and located on an outer circumferential surface of the basic body, and the plurality of first oil holes penetrate through the basic body along the radial direction and communicate with the first pressure chambers, respectively; and each of the plurality of second oil holes is provided with at least two oil sub-holes, the at least two oil sub-holes comprise a first oil sub-hole and a second oil sub-hole, the first oil sub-holes extend along a radial direction of the basic body and communicate with the second pressure chambers, respectively, the first oil sub-holes and the first oil holes are located on a same plane perpendicular to a central axis of the rotor, and the second oil sub-holes penetrate through the first end surface along an axial direction of the basic body and communicate with the first oil sub-holes, respectively.

In some embodiments, each of the plurality of second oil holes is provided with two oil sub-holes which are arranged into a shape of L.

In some embodiments, the second end surface is provided with a first groove, and an axial hole of the rotor penetrates through a bottom surface of the first groove along the axial direction.

In some embodiments, the first end surface is provided with a second groove, the second oil sub-holes penetrate through a bottom surface of the second groove, and an axial hole of the rotor penetrates through the bottom surface of the second groove along the axial direction.

In some embodiments, the first oil sub-holes penetrate through the outer circumferential surface of the basic body and do not penetrate through an inner circumferential surface of the basic body.

In some embodiments, the second oil sub-holes do not penetrate through the second end surface.

In comparison with existing technology, technical solution of the present disclosure possesses following advantages:

The plurality of first oil holes and the first oil sub-holes of the plurality of second oil holes extend along a radial direction and are located on a same plane, and the second oil sub-holes of the plurality of second oil holes extend along an axial direction, which saves the spaces on the rotor along the axial direction for arranging the plurality of first oil holes or the plurality of second oil holes. Accordingly, an axial dimension of the rotor and a mass of the rotor are reduced, thus an axial dimension of the entire camshaft phase adjuster and a mass of the entire camshaft phase adjuster are reduced.

### BRIEF DESCRIPTION OF THE DRAWINGS

FIG. 1 schematically illustrates a planar structure diagram of an existing camshaft phase adjuster;

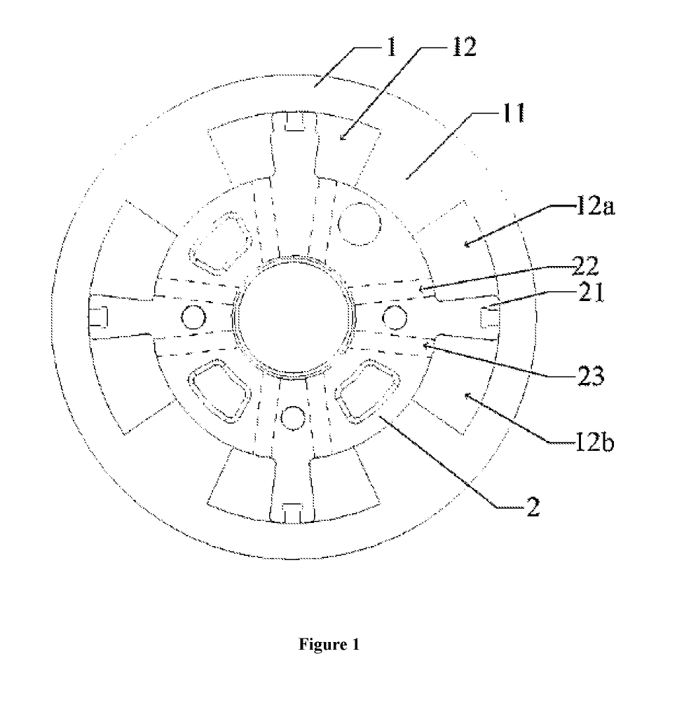

FIG. 2 schematically illustrates a side view of a rotor of the camshaft phase adjuster shown in FIG. 1;

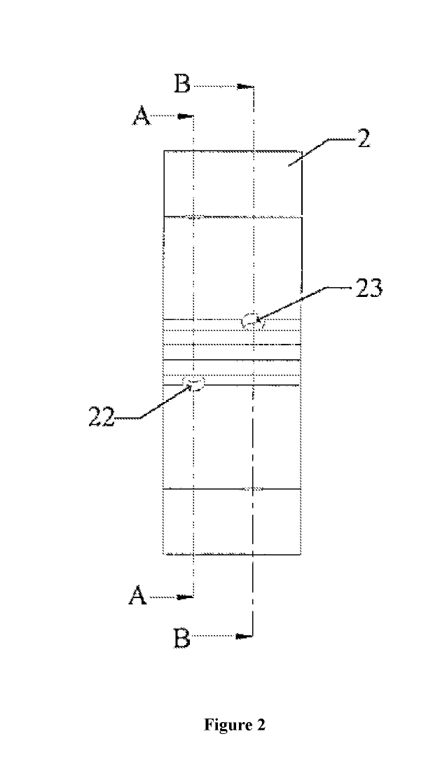

FIG. 3 schematically illustrates a sectional view along A-A of FIG. 2;

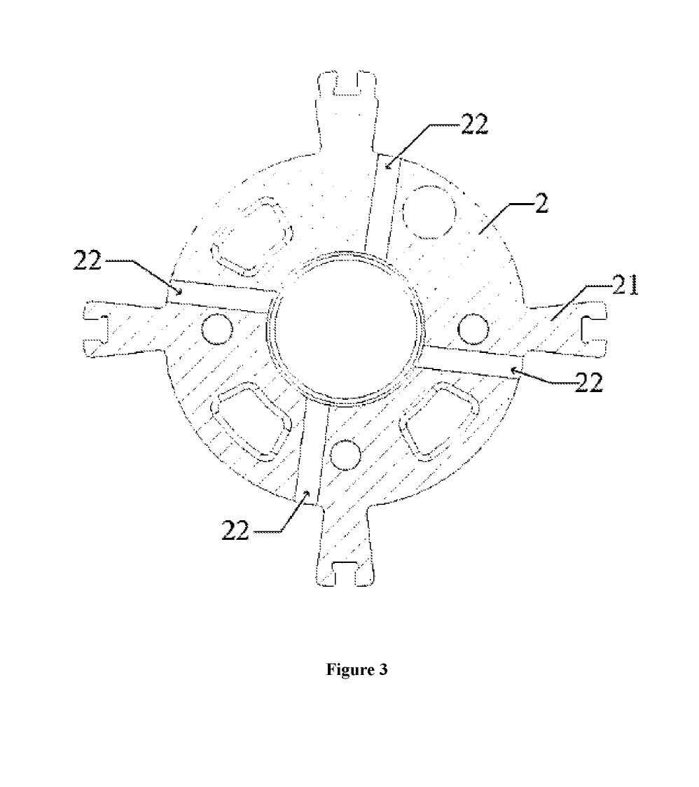

FIG. 4 schematically illustrates a sectional view along B-B of FIG. 2;

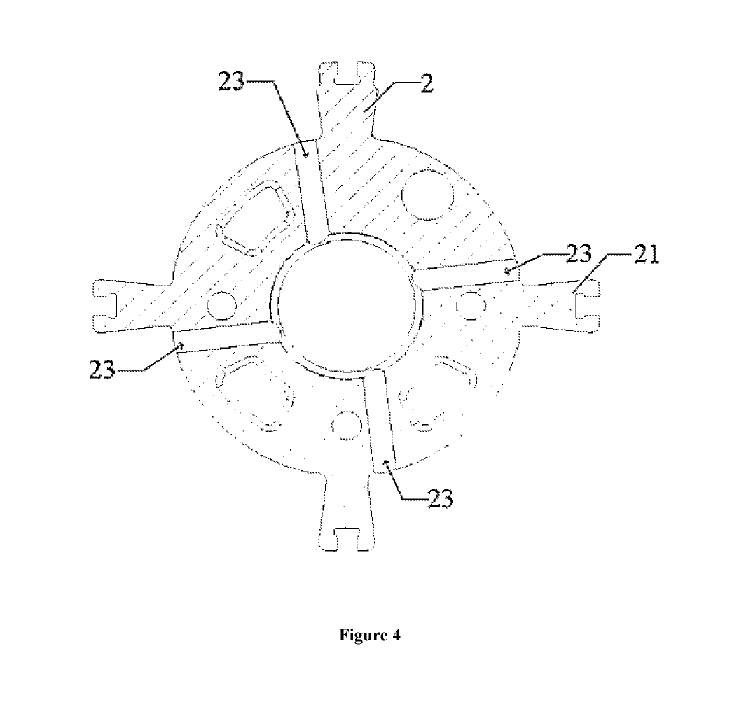

FIG. 5 schematically illustrates a three dimensional structure diagram of a camshaft phase adjuster according to one embodiment of the present disclosure;

FIG. 6 schematically illustrates a three dimensional structure diagram of a rotor in the camshaft phase adjuster shown in FIG. 5;

FIG. 7 schematically illustrates a sectional view of the rotor shown in FIG. 6 along a central axis of the rotor;

FIG. 8 schematically illustrates a partial sectional view along C-C of FIG. 6;

FIG. 9 schematically illustrates a sectional view along D-D of FIG. 7; and

FIG. 10 schematically illustrates a sectional view of an assembly between a camshaft phase adjuster and a camshaft according to one embodiment of the present disclosure.

### DETAILED DESCRIPTION OF THE PREFERRED EMBODIMENTS

In order to make objectives, features and advantages of the present disclosure clear and be easily understood, embodiments of the present disclosure will be described in detail in conjunction with the accompanying drawings.

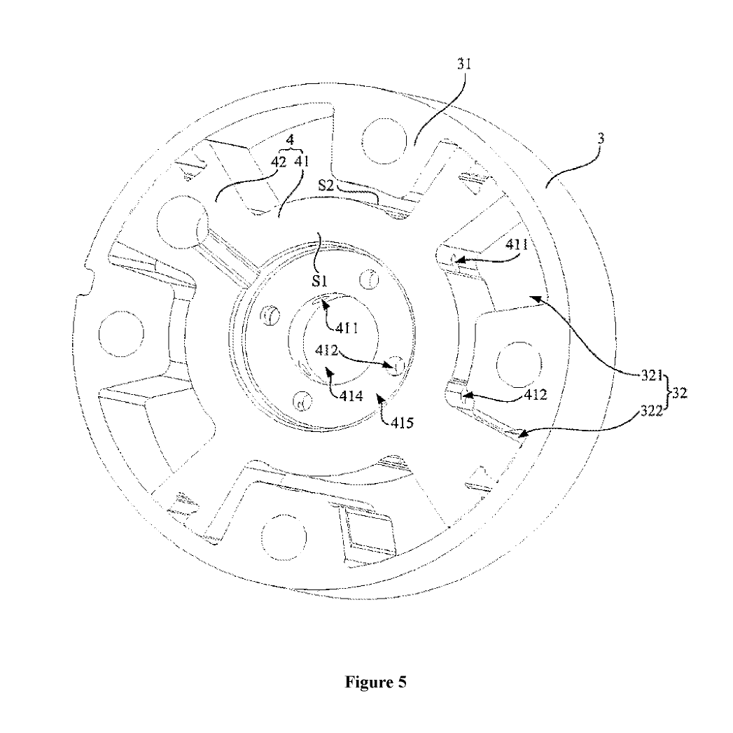

Referring to FIG. 5, a camshaft phase adjuster according to one embodiment of the present disclosure is illustrated. The camshaft phase adjuster includes: a stator 3 and a rotor 4 rotatably disposed in the stator 3.

The stator 3 is provided with a plurality of protrusions 31. The plurality of protrusions 31 are arranged in intervals along a circumferential direction and extend inwardly along a radial direction. A hydraulic chamber 32 is defined between two neighboring protrusions 31.

The rotor 4 is provided with a basic body 41 and a plurality of blades 42. The basic body 41 is provided with a first end surface S1, a second end surface S2 and an axial hole 414, wherein the first end surface S1 and the second end surface S2 face opposite directions along an axial direction. The plurality of blades 42 are arranged in intervals along the circumferential direction and outwardly extend into the hydraulic chambers 32 along the radial direction to divide the hydraulic chambers 32 into first pressure chambers 321 and second pressure chambers 322, respectively.

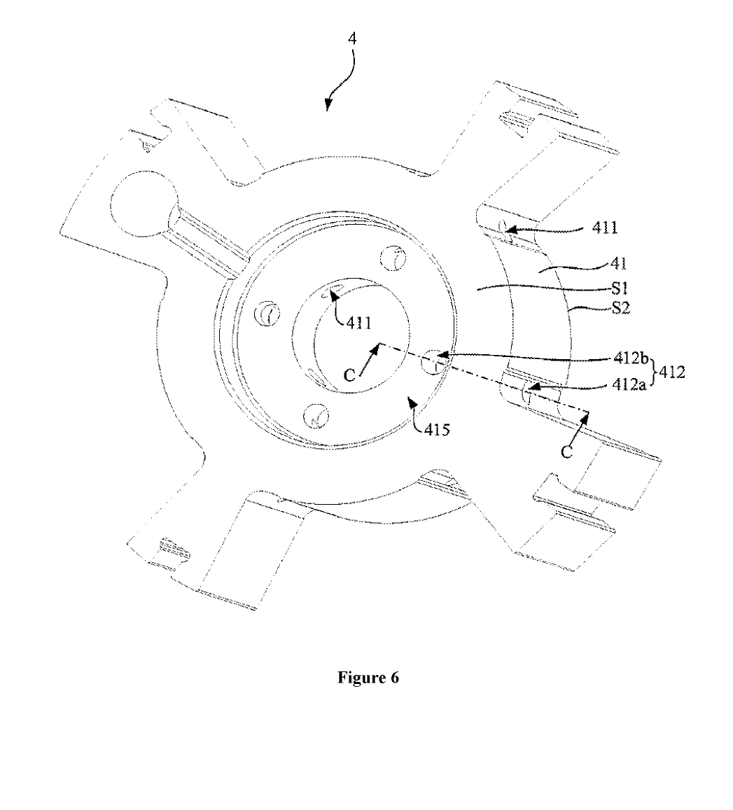

With referring to FIG. 5 and FIG. 6, the basic body 41 is further provided with a plurality of first oil holes 411 and a plurality of second oil holes 412. The plurality of first oil holes 411 are arranged in intervals along the circumferential direction and located on an outer circumferential surface of the basic body 41. The plurality of first oil holes 411 respectively communicate with the first pressure chambers 321 and penetrate through the basic body 41 along the radial direction. The plurality of second oil holes 412 respectively communicate with the second pressure chambers 322.

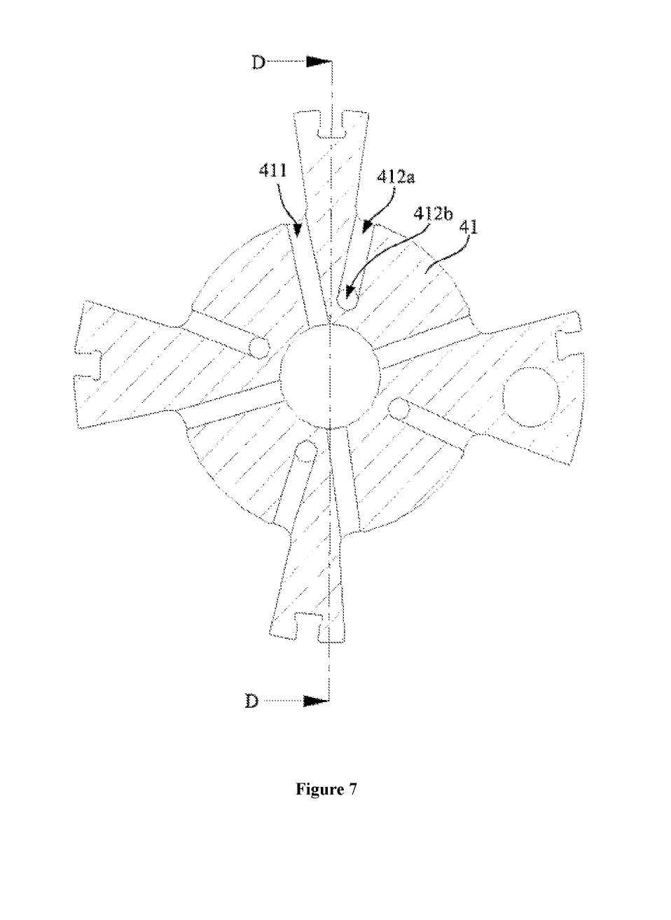

With referring to FIG. 6 to FIG. 8, each of the plurality of second oil holes 412 may include two oil sub-holes communicating with each other. The two oil sub-holes are respectively a first oil sub-hole 412a and a second oil sub-hole 412b. The first oil sub-holes 412a extend along the radial direction of the basic body 41 and penetrate through the outer circumferential surface of the basic body 41, which makes the first oil sub-holes 412a communicate with the second pressure chambers 322, respectively. The first oil sub-holes 412a and the first oil holes 411 are located on a same plane perpendicular to a central axis of the rotor 4. The second oil sub-holes 412b penetrate through the first end surface S1 along the axial direction of the basic body 41.

It should be noted that, in the technical solution of the present disclosure, as along as the first oil sub-hole 412a has one end penetrating through the outer circumferential surface of the basic body 41 and another end stopping within the basic body 41, it means that the first oil sub-hole 412a extends along the radial direction of the basic body 41, and a central axis of the first oil sub-hole 412a is not required to intersect with a central axis of the basic body 41.

Further, in the technical solution of the present disclosure, as along as the second oil sub-hole 412b has one end penetrating through the first end surface S1 of the basic body 41 and another end stopping within the basic body 41, it means that the second oil sub-hole 412b extends along the axial direction of the basic body 41, and the second oil sub-hole 412b is not required to be parallel to the central axis of the basic body 41.

In the rotor of the existing camshaft phase adjuster, the first oil hole and the second oil hole extend along the radial directions and are arranged in intervals along the axial direction. However, in the rotor of the camshaft phase adjuster provided by the present disclosure, the first oil hole and the first oil sub-hole of the second oil hole extend along the radial direction and are located on a same plane, and the second oil sub-hole of the second oil hole extends along the axial direction, which saves spaces on the rotor along the axial direction for arranging the first oil holes or the second oil holes and also saves spaces for arranging axial intervals between the first oil holes and the second oil holes. Accordingly, an axial dimension of the rotor and a mass of the rotor are reduced, thus an axial dimension of the entire camshaft phase adjuster and a mass of the entire camshaft phase adjuster are reduced.

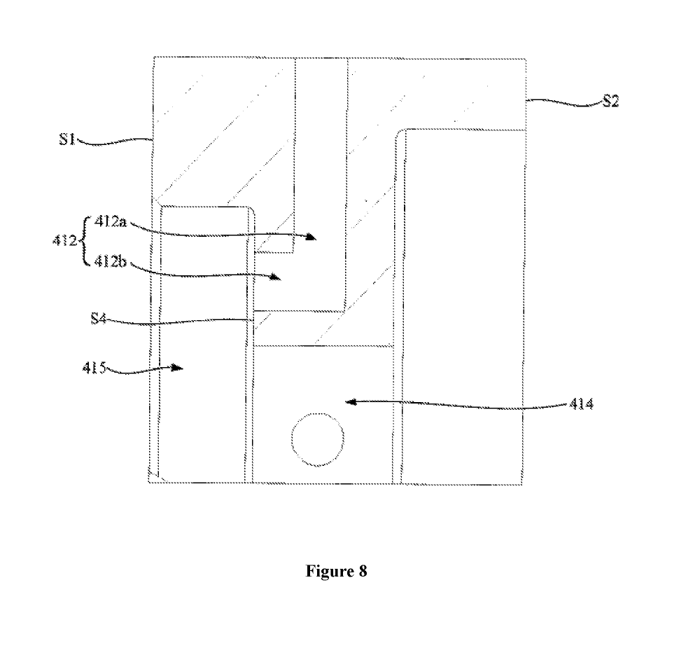

As shown in FIG. 8, in some embodiments, the first oil sub-holes 412a penetrate through the outer circumferential surface of the basic body 41, but do not penetrate through an inner circumferential surface of the basic body 41; and the second oil sub-holes 412b penetrate through the first end surface S1, but do not penetrate through the second end surface S2.

Further, the second oil hole 412 has an L-shaped cross section along the axial direction. In other words, if cutting the second oil hole 412 along the axial direction of the rotor 4, the cross section of the second oil hole 412 is L-shaped. In some other embodiments, the second oil hole 412 may have an x-shaped cross section along the axial direction, that is, the second oil sub-hole 412b and the first oil sub-hole 412a intersect and continue to extend along the axial direction after the intersection.

It should be noted that, in the technical solution of the present disclosure, a number of the oil sub-holes of the second oil hole 412 are not limited. For example, the second oil hole 412 may include another oil sub-hole located between the first oil sub-hole 412a and the second oil sub-hole 412b and communicates with the first oil sub-hole 412a and the second oil sub-hole 412b.

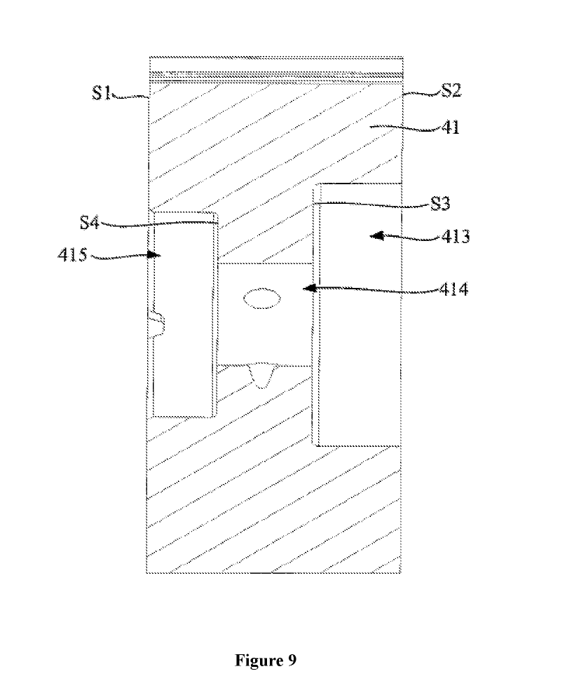

As shown in FIG. 9, the second end surface S2 of the basic body 41 may be provided with a first groove 413. One objective for configuring the first groove 413 is to reduce a mass of the basic body 41. The axial hole 414 of the rotor 4 penetrates through a bottom surface S3 of the first groove 413. It can be understood that, the first groove 413 is not limited to be configured into the shape of the present embodiment, but can be configured into any other shape, so as to reduce the mass of the basic body 41.

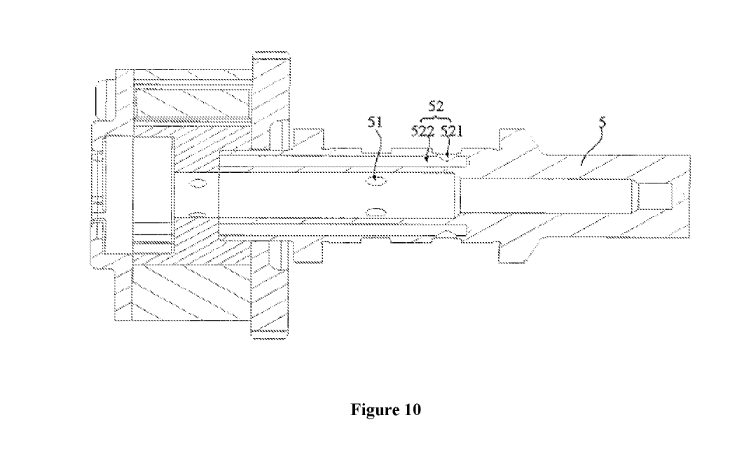

With referring to FIG. 5 to FIG. 6, and FIG. 8 to FIG. 9, the first end surface S1 of the basic body 41 may be provided with a second groove 415. The second oil sub-hole 412b penetrates through a bottom surface S4 of the second groove 415, and the axial hole 414 of the rotor 4 penetrates through the bottom surface S4 of the second groove along the axial direction. With referring to FIG. 10, when the camshaft phase adjuster is used together with a camshaft 5, an end portion of the camshaft 5 is accommodated in the second groove 415.

As shown in FIG. 10, the camshaft is provided with a plurality of first oil passages 51 and a plurality of second oil passages 52. The plurality of first oil passages 51 are arranged in intervals along a circumferential direction of the camshaft 5 and penetrate through the camshaft 5 along a radial direction of the camshaft 5. The plurality of second oil passages 52 are arranged in intervals along the circumferential direction of the camshaft 5. The second oil passage 52 is provided with a first oil sub-passage 521 and a second oil sub-passage 522. The first oil sub-passage 521 inwardly extends from an outer circumferential surface of the camshaft along the radial direction and does not penetrate through the camshaft 5. The second oil sub-passage 522 extends along the axial direction and communicates with the first oil sub-passage 521. The second oil sub-passage 522 has one end not penetrating through the camshaft 5 along the axial direction.

When the camshaft phase adjuster is put in use, a solenoid valve (not shown in FIG. 10) may be installed in an axial hole (not labeled in FIG. 10) of the camshaft 5. The solenoid valve is adapted to: switch an oil passage leading to the camshaft phase adjuster and control an oil flow according to control signals from an engine control system, so as to precisely control a rotational angle of the camshaft phase adjuster.

With referring to FIG. 10 and FIG. 6, through the solenoid valve, the plurality of first oil passages 51 respectively communicate with the plurality of first oil holes 411 of the rotor 4 in a one to one manner, and the plurality of second oil passages 52 respectively communicate with the plurality of second oil holes 412 of the rotor 4 in a one to one manner.

With referring to FIG. 10, FIG. 5 and FIG. 6, engine oil under pressure can successively flow through the first oil passage 51 of the camshaft 5 and the first oil hole 411 of the rotor and flow into the first pressure chamber 321 to drive the rotor to rotate clockwise with respect to the stator 3, so as to open an air valve in advance or after a preset delay. Or, engine oil under pressure can successively flow through the second oil passage 52 of the camshaft 5, the second oil sub-hole 412b of the second oil hole 412 and the first oil sub-hole 412a of the second oil hole 412 and flow into the second pressure chamber 322 to drive the rotor 4 to rotate anticlockwise with respect to the stator 3, so as to open the air valve after a preset delay or in advance.

Although the present disclosure has been disclosed above, but it is not limited to be so. It should be understood by those skilled in the art that various changes and modifications may be made without departing from the spirit or scope of the disclosure. Accordingly, protection scope of the present disclosure is defined by claims. CLAIMS

1. A camshaft phase adjuster, comprising:
a stator provided with a plurality of protrusions, wherein the plurality of protrusions are arranged in intervals along a circumferential direction and extend inwardly along a radial direction, and hydraulic chambers are defined between neighboring ones of the plurality of protrusions;
a rotor rotatably disposed in the stator, the rotor comprises a basic body and a plurality of blades fixed to the basic body, the basic body has a first end surface and a second end surface which face opposite directions along an axial direction, the plurality of blades are arranged in intervals along the circumferential direction and outwardly extend into the hydraulic chambers along the radial direction to divide the hydraulic chambers into first pressure chambers and second pressure chambers, respectively;
the basic body is provided with a plurality of first oil holes and a plurality of second oil holes, the plurality of first oil holes are arranged in intervals along the circumferential direction and located on an outer circumferential surface of the basic body, and the plurality of first oil holes penetrate through the basic body along the radial direction and communicate with the first pressure chambers, respectively;
each of the plurality of second oil holes is provided with at least two oil sub-holes, the at least two oil sub-holes comprise a first oil sub-hole and a second oil sub-hole, the first oil sub-holes extend along a radial direction of the basic body and communicate with the second pressure chambers, respectively, the first oil sub-holes and the first oil holes are located on a same plane perpendicular to a central axis of the rotor, and the second oil sub-holes penetrate through the first end surface along an axial direction of the basic body and communicate with the first oil sub-holes, respectively.

2. The camshaft phase adjuster according to claim 1, wherein each of the plurality of second oil holes is provided with two of the oil sub-holes which are arranged into a shape of L.

3. The camshaft phase adjuster according to claim 1, wherein the second end surface is provided with a first groove, and an axial hole of the rotor penetrates through a bottom surface of the first groove along the axial direction.

4. The camshaft phase adjuster according to claim 1, wherein the first end surface is provided with a second groove, the second oil sub-holes penetrate through a bottom surface of the second groove, and an axial hole of the rotor penetrates through the bottom surface of the second groove along the axial direction.

5. The camshaft phase adjuster according to claim 1, wherein the first oil sub-holes penetrate through the outer circumferential surface of the basic body and do not penetrate through an inner circumferential surface of the basic body.

6. The camshaft phase adjuster according to claim 1, wherein the second oil sub-holes do not penetrate through the second end surface.
